(19) United States
(12) Patent Application Publication
(10) Pub. No.: US 2017/0263397 A1
(43) Pub. Date: Sep. 14, 2017

(54) High Voltage Disconnection Telescopic Switches Isolated by Air for Isolated-Phase Bus

(71) Applicant: Mikhail Sotnikov, Saint Bruno (CA)

(72) Inventor: Mikhail Sotnikov, Saint Bruno (CA)

(21) Appl. No.: 15/529,852

(22) PCT Filed: Nov. 26, 2015
(86) PCT No.: PCT/CA2015/051236

§ 371 Date: May 25, 2017

(30) Foreign Application Priority Data
Nov. 26, 2014 (MX) MX/A/2014/014430

(51) Int. Cl. H01H 31/32; H01H 11/00; H01H 1/38

(52) U.S. Cl. CPC H01H 31/32; H01H 1/38; H01H 11/00; H01H 2201/026

(57) ABSTRACT

This invention relates to a telescopic switch for isolated-phase bus duct, comprising: a first male conductor including a first guide-positioner means (4); a 5 second female lead connector coaxially separated from the first connector which includes a second guide-positioning means, wherein said moving contact is coupled coaxially and in a movable manner to the first conductor, and wherein said moving contact moves to an open position, wherein said moving contact is separated from the first conductor and to a closed position where said moving contact causes a contact between the first male connector and that of a second female connector, through interaction with one another from the first guide-positioner means of the first conductor, the second guide-positioner means of the second conductor and the guiding means of the moving contact.

### CROSS REFERENCE TO RELATED APPLICATIONS

This application is a 371 of International Application No. PCT/CA2015/051236, filed on Nov. 26, 2015, which claims priority to Mexican Patent Application No. MX/a/2014/014430 filed Nov. 26, 2014, the disclosures of which are incorporated herein by reference in their entirety.

### TECHNICAL FIELD OF THE INVENTION

This invention is related to electrical interruption devices, and particularly to high voltage, disconnection telescopic switches of high current for bus of isolated-phase bus from a power generation station.

### INVENTION BACKGROUND

The high voltage disconnection telescopic switches are an essential part of the system of isolated-phase bus for power stations. They are installed inside the isolated-phase bus and are designed to isolate different sections of the grid within the power station.

Usually, a high voltage telescopic switch consists of a female lead connector, a male lead connector and a cylindrical moving contact, all of them coaxially installed. The electrical connection is established amongst three main components by the number of individual contact fingers disposed outside the circumference of the female and male lead connectors.

The contact force can be supplied by different spring systems that includes one individual coil and flat spring and/or by mutual tension springs.

In the open position, the moving part is located within the male lead connector. With the aim of making a physical separation and/or a contact between both moving lead connectors, the connector moves between the male and female lead connectors in a linear movement manner.

Bus bars where the telescopic switches are installed in might be cylindrical and/or polygonal, and the contact systems are based on cylindrical constructions.

The usual number of interfaces for electrical contacts is 4; from the female lead connector to the contact finger, from the contact finger to the moving contact, from the moving contact to the finger contact and from the contact finger to the male lead connector.

The electrical contacts between the moving contact and the contact fingers slip off with the interruption of 5 physical links; the electrical contacts between the female and male lead connectors, and the fingers are stable without the interruption of a physical link.

The female and male lead connectors are commonly made of aluminum alloys, moving connectors may be manufactured with copper and/or aluminum alloys and the finger contacts are manufactured with coper alloys.

The size and weight of the telescopic switches and their layout within the isolated-phase bus make it difficult to replace the female and male lead connectors in the event of any damage caused by the electric arc and/or wear.

The optimal disconnection telescopic switch must have a minimum number of contact interfaces, a low transition resistance, a low operating force, without contact wear, high nominalcurrent, a short-circuit capacity, a corrosion resistant construction, capacity to withstand thermal shock; it has to be capable of adjusting the misalignments, light weight and ability to be easily inspected and replaced.

### SUMMARY OF THE INVENTION

In one aspect, the invention provides a telescopic switch for isolated-phase bus duct, comprising:a first male lead connector (1) comprising an aluminum base (1a) and a first-guide positioning means (4); a second female lead connector (2) coaxially separated from the first connector (1), said second female lead connector (2) including an aluminum base (2a) and a second guide-positioning means (5); supporting guiding means (32, 33) that comprises a front support guide (32) and a back support guide (33), a moving contactor (3) which comprises the back guiding support (32) and a plurality of contact plates (33) coupled to the peripheral edges of each front guiding support (32) and the back guiding support (33), wherein said moving contact (3) is coupled coaxially and in a movable manner to the first male conductor (1); and wherein said moving contact (3) moves to an open position so that the moving contact (3) is separated from the first conductor (1) and to a closed position where said moving contact (3) causes contact between the first male connector (1) and that of a second female connector (2), through interaction with one another from the first guide-positioner means (4) of the first conductor (1), the second guide-positioner means (5) of the second conductor (2) and contact plates (31) coupled to the guiding means (32, 33) of the moving contact (3).

With the structural and technical features of this invention, the following aims are pursued:

The first aim of this invention is to supply a high voltage disconnection telescopic switch isolated by air of high voltage for an isolated-phase bus of a rapid change of the parts for the electrical contacts without removing the telescopic disconnection switch from the isolated-phase bus. The female lead connector (2) of the modular construction, the male lead connector and the moving contact will allow the replacement of any part which may be subject to catastrophic failure without removal of the main bases that connect to the distribution busbars (bus).

Another aim of this invention is to provide a disconnector telescopic switch with only two interfaces of moving contact and two fixed contact interfaces. The contact fingers of reduced aluminum section that are mechanically fixed to the polygonal bases provide the necessary displacement for the moving contact (3) between them and the contact plates.

Another aim of this invention is to provide a disconnection telescopic switch with polygonal flat contact surfaces which allow to obtain a reliable line contact between the contact plates and the contact fingers of reduced aluminum section.

Another aim of this invention is to provide a disconnection telescopic switch with identical contact fingers so that the female and male lead connectors (2) provide both connectors with equal force of contact and section. The use of identical connectors will help in installation errors and minimize the number of different components in the assembly.

Another aim of this invention is to provide a disconnection telescopic switch with a construction which removes pressure to the finger contact during displacement and enables the reduction of the mechanical wear of interfaces and the decrease of the operational force of the disconnector.

Another aim of the invention is to provide a disconnection telescopic switch with a contact force obtained only by the elastic deformation of the fingers reduced aluminum section. The displacement of the reduced aluminum section to the distances provided will result in a calculated force provided by the elastic deformation of the aluminum and sufficient for the expected current.

Contact fingers are assembly pressure release elements, where the displacement of the finger determines the contact pressure.

Another aim of this invention is to provide a disconnection telescopic switch with adjustment of the total operating force of the contact, by precisely selecting the number of contact extensions and the pressure value of each contact extension.

Another aim of this invention is to provide, from the disconnection telescopic switch, capacity to the increase of the number of individual contact fingers, reducing the width of the separate section of each finger.

Another aim of this invention is to provide a disconnection telescopic switch with the possibility of adjustment to a higher current intensity, changing only the contact fingers and the contact plates. The section of the male and female bases is usually over-size and a number of fingers is limiting the element of the disconnecting ability of the switch; the fingers of reduced aluminum section can be adjusted to a larger cross section of aluminum and greater contact force without the need for a larger circumference of the contact base.

Another aim of this invention is to provide a disconnection telescopic switch with moving contact that uses contact plates with different lengths and will initiate physical contact with the fingers of the female lead connector, thus gradually reducing the maximum mechanical forces.

Another aim of this invention is to provide a disconnection telescopic switch with convection cooling of the moving contact and of the contact fingers, by the circulation of air through the spaces 25 between contact fingers and contact plates.

Another aim of this invention is to provide a disconnection telescopic switch with low operating force by the start of the back contact prior to the initiation of the front contact.

Another aim of this invention is to provide a disconnection telescopic switch with power distribution in moving modular contact through electrical contact to lead it to the front and back support. All contact plates of moving modular contactor join the front and back supports, which are manufactured in aluminum and will allow distribution of electrical power between them.

Another aim of this invention is to provide a disconnection telescopic switch with a ball screw and a mechanical ball bearing system to allow a low and constant power operation.

Another aim of this invention is to provide a disconnection telescopic switch with a limiting system of internal orbital displacement.

Another aim of this invention is to provide a disconnection telescopic switch with an orbital internal positioning system that will ensure the coaxial positioning of the moving contact after closing.

Another aim of this invention is to provide a disconnection telescopic switch with a manufacturing free of copper.

Another aim of this invention is to provide a disconnection telescopic switch with all manufacture free of aluminum welding by machining and/or extrusion of the core components.

Another aim of this invention is to provide a disconnection telescopic switch with adaptability to any type of busbar (bus) of isolated-phase. The machining of the male and female connecting bases of solid aluminum extrusions allows for a manufacturing that adapts to cylindrical and/or polygonal distribution busbars (bus).

Another aim of this invention is to provide a disconnection telescopic switch with a manufacture that uses materials with relatively low magnetic permeability for the system of critical components.

These purposes and features are achieved by the modular telescopic disconnection switch of high voltage, isolated by the invention air, which comprises a modular manufacturing, the use of contact fingers from the aluminum reduced section, high operation accuracy, high adaptability to misalignments, adaptable and precisely calculated electric parameters (A/mm2, A/mm, A/kgf), useful contact area, constant and precise contact pressure, limited sliding contact, extensions of independent contacts, use of a floating pressure distribution, with a useful contact pressure, low approaching angles of minimum effort, high conductivity of the component materials, high efficiency of oxide removal during sliding movement, low stationary resistance of the contacts due to the use of solid silver.

### BRIEF DESCRIPTION OF THE FIGURES

FIG. 1a, is a cross-sectional view of the telescopic switch from this invention in its closed position.

FIG. 1b, is a cross-sectional view of the telescopic switch from this invention in its opened position.

FIG. 1c, is a perspective view of the telescopic switch from this invention in its closed position.

FIG. 1d, is a perspective view of the telescopic switch from this invention in its opened position.

FIG. 2, is a perspective view of the second lead connector of female configuration.

FIG. 3, is a perspective view of the second lead connector in female configuration exemplifying the 15 guide-positioning means.

FIG. 4, is a perspective view of the first lead connector of male configuration.

FIG. 5, is a perspective view of the first lead connector in female configuration exemplifying the guide-positioning means.

FIG. 6, is a perspective view of the moving contact.

FIG. 7, is a perspective view of the support of the moving contact.

FIG. 8, is a perspective view of the contact plate.

FIG. 9a, is a perspective view of the first lead connector in female configuration exemplifying the internal components.

FIG. 9b, is a perspective view of the first lead connector in female configuration exemplifying the external components.

FIG. 9c, is a perspective view of the mechanical system from this invention.

### DETAILED DESCRIPTION OF THE INVENTION

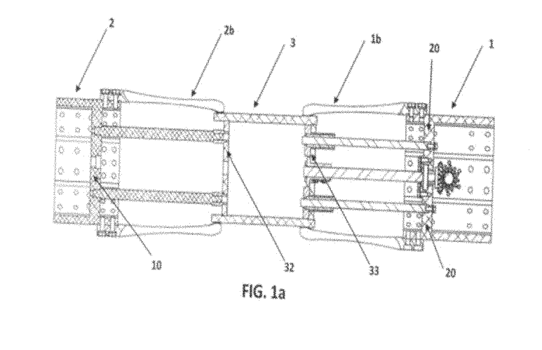

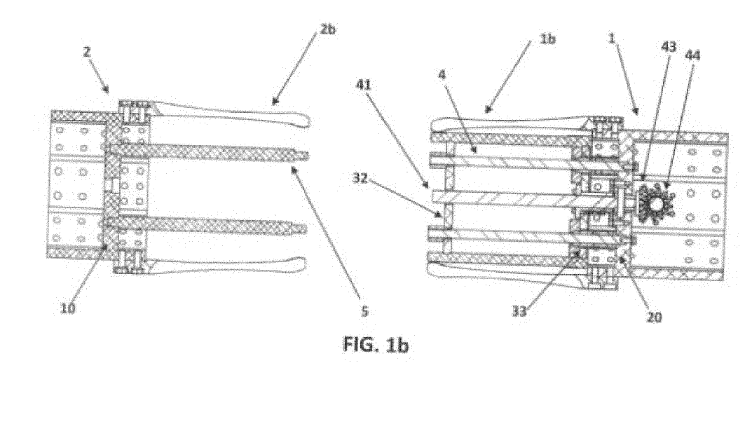

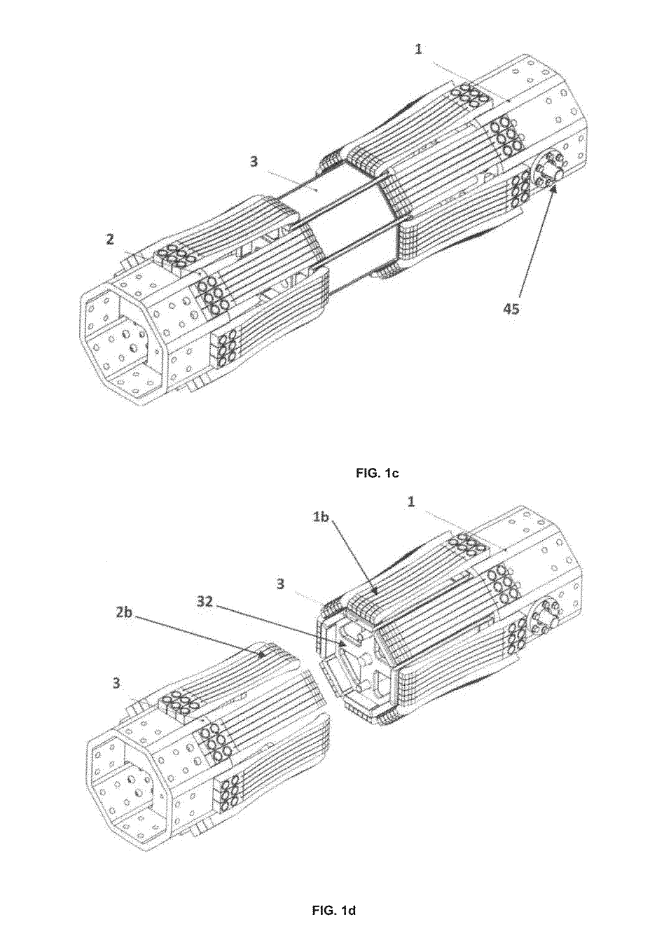

In accordance with to the FIGS. 1-9c shown, this invention relates to construction of disconnection telescopic switches, to their maintenance and integration into the isolated-phase bus. The moving contact systems of this invention are designed to provide a distribution device with a smaller number of contact interfaces, low resistance and precise calculated operating force. The moving contact (3) of this invention is designed to be a polygonal modular construction with independent contact plates.

This invention is conducted to provide a disconnection telescopic switch with flat sliding contact between contact fingers (1b, 2b) and a moving contact (3).

With this invention, it is intended that all of the contact assembly elements be manufactured by machining, xtrusion and/or stamping and to supply a constructive assemblage solderless.

The disconnection telescopic switch of the invention consists of a first lead conductor (1) having a male polygonal configuration, a second lead conductor (2) having a female polygonal configuration, a moving modular contact (3) and a mechanical system, as illustrated in FIGS. 1a-1d.

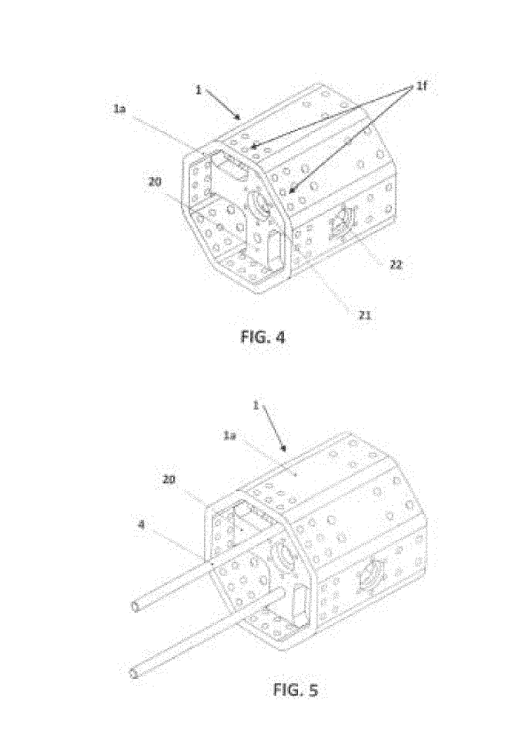

The first male lead connector (1) consists of an aluminum base (1a), with fingers (1b) of reduced aluminum section and a first guide-positioning system (4). The aluminum base (1a) has a polygonal tubular body with an internal intermediate section (20), having said inner intermediate (20) a first bearing central bore (21), and at least two coupling bores (20a) as is illustrated in FIG. 4. Fingers (1b) of reduced multiple and/or single aluminum section are screwed on a flat surface of a front area (1f) of the aluminum base (1a); in addition, one of the flat surfaces of the aluminum base (1a) comprises a second bearing central bore (22). Those with finger (1b) aluminum reduced section are formed of an elongated rectangular configuration having a first end in one piece, of which a plurality of contact fingers (1b) emerge, said first end of one piece having a 5 plurality of passed coupling bores which couple through screw to a flat surface of a front area (1f) of the aluminum base (1a).

The first guide-positioning system (4) is constructed of at least two guides which support the moving contact (3) during the sliding, wherein said first guide-positioning system (4) is installed in an intermediate section (20) of the aluminum base (1a), being coupled to the coupling bores (20a) of the intermediate section (20), as illustrated in FIG. 5. The intermediate section (20) of the aluminum base (1a) is in one piece, which provides structural rigidity.

The second lead conductor (2) such as a female lead conductor (2) consists of an aluminum base (2a) with fingers (2b) of small aluminum section and a second guide-positioning system (5).

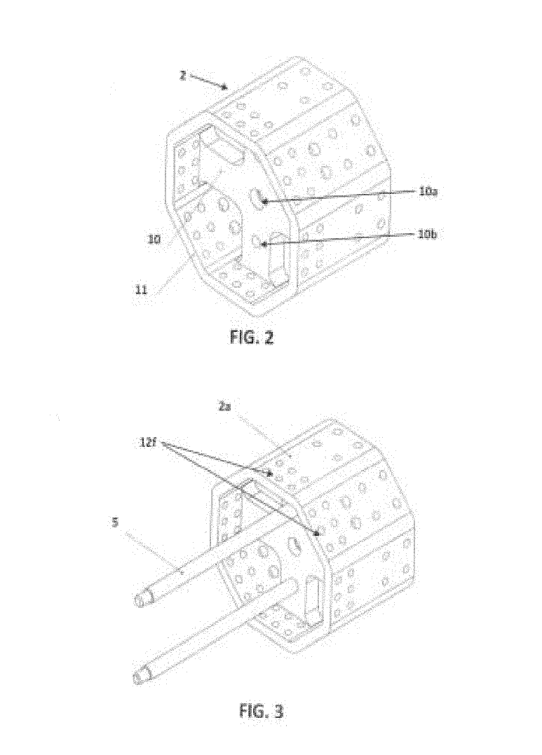

The aluminum base (2a) has a polygonal tubular body (11) with an internal intermediate section (10), as illustrated in FIG. 2. The fingers (2b) of multiple and/or single aluminum reduced section are screwed to a flat surface of a front area (2f) of the aluminum base (2a), such fingers (1b) of aluminum reduced section are formed of an elongated rectangular configuration having a first end in one piece, of which a plurality of contact fingers (2b) emerge, said first end of one piece having a plurality of passed coupling bores which couple through screw to a flat surface of a front area (2f) of the aluminum base (2a).

The contact fingers (1b, 2b) are identical for both the first male lead conductor (1) and the second female lead connector (2); and further, an increase in the number of individual contact fingers is allowed, reducing the width of the separate section of each finger. Another essential feature is that convection cooling of the moving contact (3) and of the contact fingers is provided by the circulation of air through the spaces between contact fingers and contact plates.

The second guide-positioner (5) system is constructed of at least two guides that limit the movement of the moving contact (3) and the position of the same movable contact (3) in the center of the female lead connector (2). The second guide-positioner (5) system is installed in the intermediate section (10) of the aluminum base (2a), as illustrated in FIG. 3, and further it configures a limiter system of displacement consisting of stainless steel shafts and inserted in bronze, positioned in an orbital manner within the male and female lead connectors.

The moving modular contactor (3) comprises contact plates (31) and guiding support means (32, 33), wherein said moving contact (3) is coupled coaxially and in a movable manner to the first conductor (1); and wherein said moving contact (3) moves to an open position so that the moving contact (3) is separated from the first conductor (1) and to a closed position where said moving contact (3) causes contact between the first male connector (1) and that of a second female connector (2), through interaction with one another from the first guide-positioner means (4) of the first conductor (1), the second guide-positioner means (5) of the second conductor (2) and the guiding means (32, 33) of the moving contact (3).

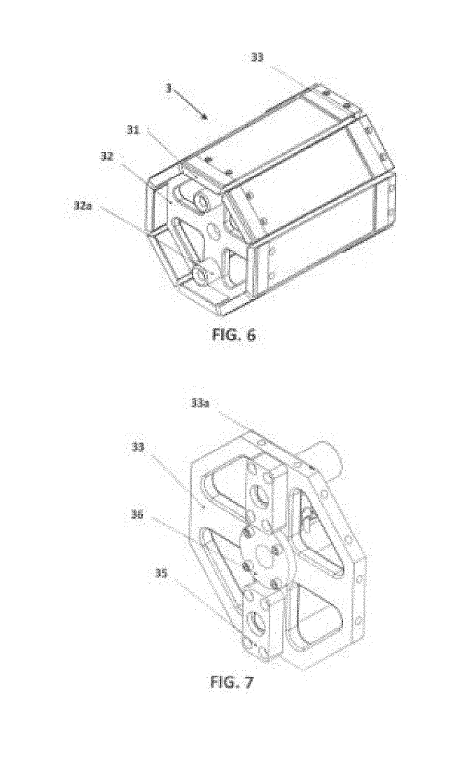

The means of guiding support (32, 33) of the moving modular contactor (3) comprise a front guiding support (32) and a back guiding support (33), as illustrated in FIGS. 6 and 7.

The front guiding supports (32) and back guiding (33) are polygonal and have a matching number of sides for male (1) and female (2) lead connectors. The front guiding support (32) has hubs (32a) designed to interact with the guide-positioning system (4) of the female lead connector (2) to place the moving connector (3) and to limit its displacement.

The back support (33) has at least two sliding hubs/bearings (35) sliding on the guides of the first guide-positioner system (4) of the male lead connector (1). The telescopic switch of this, further includes a ball screw nut (36) installed in the center of that back support (33), as illustrated in FIG. 7. The front guiding support (32) and the back guiding (33) have coupling peripheral edges (32a), which have bores to couple contact plates in a screwed manner (31).

Contact plates (31), in their preferred modality, have an elongated rectangular configuration so that two different levels in height in each of its ends are formed, thus forming a back section (31a) and a front section (31b); the back section (31a) of said contact plate (31) is higher and is contacted with the fingers (1b) installed on the male connector (1) at the end of the displacement, i.e. when this is in its closed position.

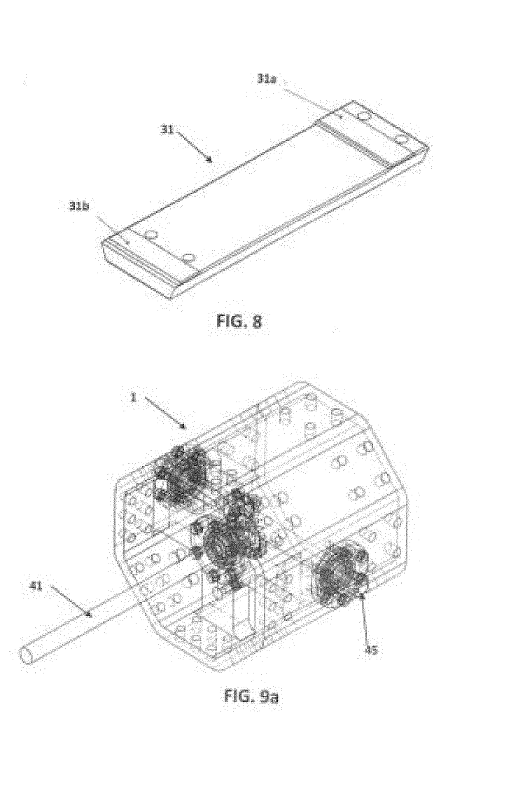

The front section (31b) of said contact plate (31) is lower in height as compared with the back section (31a), and its function is to contact the fingers (2b) of the female connector (2) when this is in a closed position, as illustrated in FIG. 8.

Opposite contact plates (31) form a pair of plates and their function is to physically interact with the contact fingers (2b) at the same time, whereas the length of other pairs of contact plates have different lengths to avoid the maximum mechanical load at the start of the connection. Contact fingers and contact plates (31) will be coated with a silver coating.

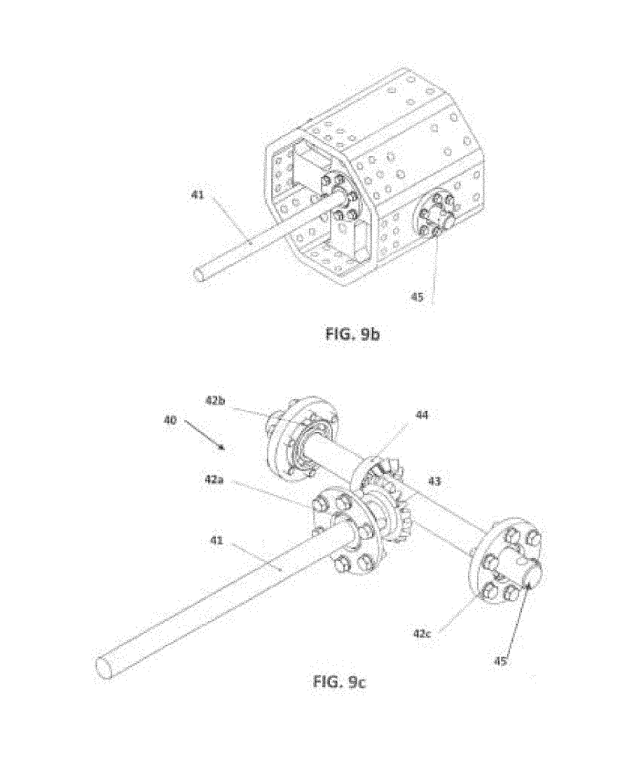

In order to perform the movement of the modular moving contact (3) from a closed position to a opened position, the telescopic switch of this invention includes a mechanical system (40) placed within the aluminum base (1a) of the first male deal connector (1) and coupled with and coupled to the internal intermediate section (20) from the aforementioned first male lead connector (1). The mechanical system (40) consists of a ball screw (41) consisting of a first end placed in a ball bearing (42a) mounted over the first bearing central bore (21) of the internal intermediate section (20); the ball screw (41) has such a length that it can take and move itself coaxially to the moving modular contact (3). The ending of the ball screw end (41) includes a first bevel gear (43) which mechanically attaches itself to a second bevel gear (44). A main axis (45) mounted on bearings (42b, 42c) in the second central bearing bore (22) of the aluminum base (1a) of the first male connector (1) is the one that transmits movement to the first bevel gear (43) of the spherical screw (41) through a second bevel gear (44). The rotation of the main shaft (45) 10 rotates the ball bearing (42a) and, therefore, displaces the moving connector (3), as illustrated in FIGS. 9a-9c.

The distance between the finger contact surfaces (2b) of the female lead connector (2) is smaller than the distance between contact plates (31) of the front area of the moving contact (3); the movement of the moving contact (3) will move the finger contact (2b) to the predicted distance and an elastic deformation of aluminum will provide a disconnection telescopic switch with the necessary contact force. The same thing applies to the finger of back contact (1b) of the male lead connector (1) in the movement end, the largest selection of the contact plates (31) will displace the contact fingers (1b) and the electrical contact will be set.

1. A telescopic switch for isolated-phase bus duct, comprising:
a first male lead connector (1) comprising an aluminum base (1a) and a first-guide positioning means (4);
a second female lead connector (2) coaxially separated from the first connector (1), said second female lead connector (2) including an aluminum base (2a) and a second guide-positioning means (5);
supporting guiding means (32, 33) that comprises a front support guide (32) and a back support guide (33),
a moving contactor (3) which comprises the back guiding support (32) and a plurality of contact plates (33) coupled to the peripheral edges of each front guiding support (32) and the back guiding support (33), wherein said moving contact (3) is coupled coaxially and in a movable manner to the first male conductor (1); and
wherein said moving contact (3) moves to an open position so that the moving contact (3) is separated from the first conductor (1) and to a closed position where said moving contact (3) causes contact between the first male connector (1) and that of a second female connector (2), through interaction with one another from the first guide-positioner means (4) of the first conductor (1), the second guide-positioner means (5) of the second conductor (2) and contact plates (31) coupled to the guiding means (32, 33) of the moving contact (3).

2. A telescopic switch for duct of isolated-phase bus, in accordance with claim 1, comprising two moving contact interfaces such as a back section (31a) of said contact plate (31) and a front section (31b), as well as two fixed contact interfaces such as contact fingers (1b, 2b) of reduced aluminum section, which are coupled to each aluminum base (1a, 2a) of the first male lead connector (1) and the second female lead conductor (2).

3. A telescopic switch for duct of isolated-phase bus, in accordance with claim 1, characterized in that the contact fingers and the contact plates (31) are coated with a silver coating.

4. A telescopic switch for duct of isolated-phase bus, in accordance with claim 1, characterized in that the contact force is obtained only from the elastic deformation of the fingers of reduced aluminum section.

5. A telescopic switch for duct of isolated-phase bus, in accordance with claim 1, characterized in that the contact plates (31) have flat contact surfaces.

6. A telescopic switch for duct of isolated-phase bus, in accordance with claim 2, characterized in that the contact fingers (1b, 2b) are identical for both the first male lead connector (1) as well as for the second female lead connector (2).

7. A telescopic switch for duct of isolated-phase bus, in accordance with claim 2, characterized in that the back section (31a) of said contact plate (31) is higher than the front section (31b), and is in contact with the fingers (1b) installed on the male lead connector (1) at the end of the displacement.

8. A telescopic switch for duct of isolated-phase bus, in accordance with claim 1, characterized in that in the configuration of the contact fingers (1b, 2b), an increase in the number of individual contact fingers are allowed, reducing the width of the independent section of each finger.

9. A telescopic switch for duct of isolated-phase bus, in accordance with claim 1, characterized in that the moving contacts (3) are produced from aluminum or copper alloys.

10. A telescopic switch for duct of isolated-phase bus, in accordance with claim 2, characterized in that the contact fingers are produced from copper alloys.

11. A telescopic switch for duct of isolated-phase bus, in accordance with claim 1, characterized in that opposite contact plates (31) form a pair of plates and their function is to physically interact with the contact fingers at the same time, whereas the length of other pairs of contact plates have different lengths to avoid the maximum mechanical load at the start of the connection.

12. A telescopic switch for duct of isolated-phase bus, in accordance with claim 1, characterized in that the back support (33) has at least two sliding hubs/bearings (35) that moves on the guides of the first guide-positioner system (4) of the male lead connector (1).

13. A telescopic switch for duct of isolated-phase bus, in accordance with claim 1, characterized in that said switch is manufactured in a modular fashion.
